(19) United States
(12) Patent Application Publication
(10) Pub. No.: US 2010/0118433 A1
(43) Pub. Date: May 13, 2010

(54) WRITE PRECOMPENSATION SYSTEM

(76) Inventor: Bruce Douglas Buch, Westborough, MA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(21) Appl. No.: 12/266,677

(22) Filed: Nov. 7, 2008

(51) Int. Cl. G11B 21/02

(52) U.S. Cl. 360/75; G9B/21.023

(57) ABSTRACT

A write precompensation system comprises a write precompensation processor that calculates time shift information for the timing of individual write current transitions at a write head to coincide with a media pattern under the write head and a write precompensation controller that shifts the individual write current transitions in accordance with the time shift information.

### BACKGROUND OF THE INVENTION

The invention relates generally to data processing systems that utilize bit patterned media and, more particularly, to such systems that perform write precompensation.

Read/write channels in continuous media recording systems provide write precompensation to shift timing of individual write current transitions to compensate for shifts of the corresponding magnetic transitions in the recording medium that are caused by demagnetizing fields. The demagnetizing fields correspond to the particular data bits that are being recorded, and the channel maintains a short history of the data bits in, for example, a shift register. The channel uses the data contained in the shift register to enter a look-up table that contains precompensation values that the channel applies to shift respective write current transitions before they are written to the media. The shifts in the recording media that are caused by associated demagnetizing fields then result in more evenly spaced magnetic transitions in the media.

Bit pattern media (BPM) consists of magnetic material, sometimes referred to as dots, arranged in discreet patterns in nonmagnetic material. The positions of magnetic transitions in a data stream written to BPM are fixed at the positions of the dots. Accordingly, there is no need to precompensate for shifts of the magnetic transitions associated with demagnetizing fields. However, other aspects of BPM recording compels a need for a write precompensation mechanism.

### SUMMARY OF THE INVENTION

A write precompensation system comprises a write precompensation processor that calculates time shift information for the timing of individual write current transitions at a write head to coincide with a media pattern under the write head, and a write precompensation controller that shifts the individual write current transitions in accordance with the time shift information.

### BRIEF DESCRIPTION OF THE DRAWINGS

The invention description below refers to the accompanying drawings, of which:

FIG. 1 illustrates bit patterned media (“BPM”);

FIGS. 2A-B illustrates BPM with sub-tracks;

FIGS. 3A-C illustrates write head positions relative to the sub-tracks;

FIGS. 4A-B are functional block diagrams of a write precompensation system for use with BPM;

FIG. 5 is a functional block diagram including a multi-phase interpolation mixer in the system of FIGS. 4A-B;

FIG. 6 is a more detailed functional block diagram of the multi-phase interpolation mixer of FIG. 5; and

FIG. 7 is a functional block diagram of an alternative to the multi-phase interpolation mixer of FIG. 5.

### DETAILED DESCRIPTION OF AN ILLUSTRATIVE EMBODIMENT

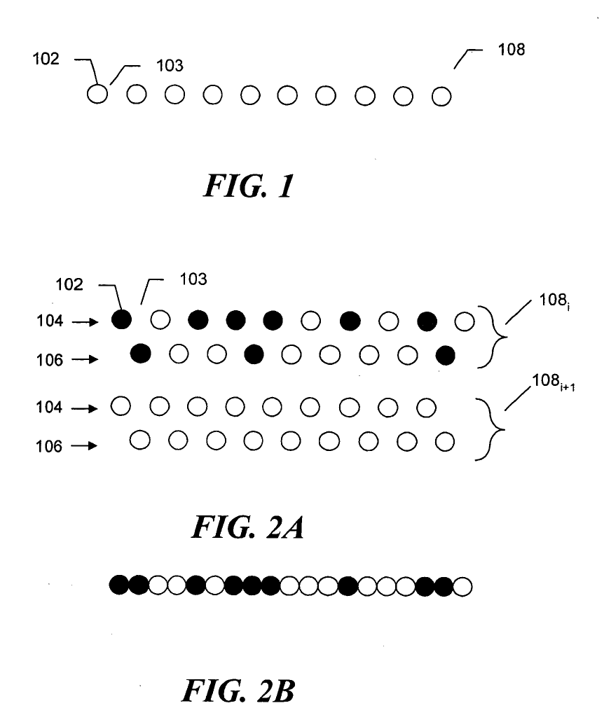

Referring to FIG. 1, bit patterned media (BPM) consists of magnetic material, or dots, 102 arranged in patterns in non-magnetic material 103. The respective dots in a track 108 are in close proximity to one another, and write transitions at a write head, or writer must be precisely aligned with the dots, such that the data are recorded therein. Otherwise, a single dot may experience conflicting magnetization forces from the writer, resulting in a bit of in determinant state being written.

For efficient utilization of BPM capacity, a write channel must precisely control the timing of the transitions in a data stream, such that the respective transitions coincide at the write head with the dots 102 under the write head. The timing of individual transitions in a random data stream can be shifted by bandwidth limitations and/or non-linearities of some or all of the components in the write channel. For example, transitions from negative to positive or positive to negative may be slightly delayed by different amounts of time in a number of the components. BPM write precompensation provides a compensating shift to a write transition before the write transition enters the write channel. Thereafter, the delays introduced by respective write channel components shift the transition such that the transition arrives at the write head at a time that coincides with a dot 102 being under the write head.

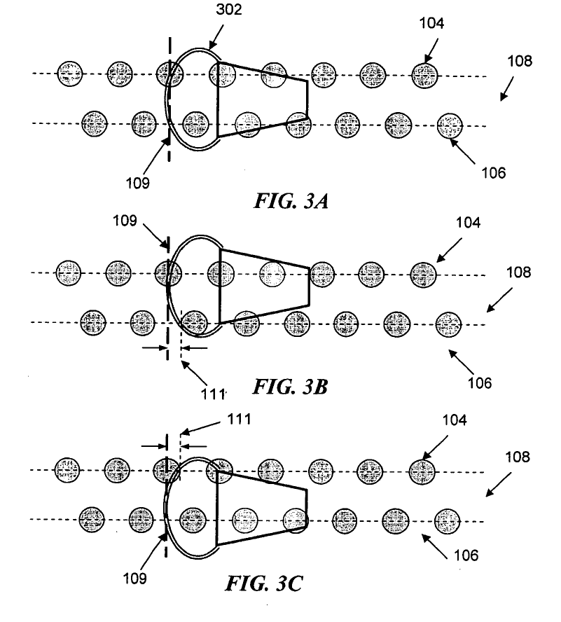

Referring now to FIGS. 2A-B, BPM dots 102 are positioned in even and odd sub-tracks 104, 106 that together are a track 108ᵢ, 108ᵢ₊₁, and so forth. A reader (not shown) reads dots from the two sub-tracks as one logical track, with transitions in the read signal corresponding to an even dot, an odd dot, an even dot, an odd dot, and so forth. FIG. 2B illustrates the read signal that corresponds to reading the darkened and light dots in the logical track 108ᵢ.

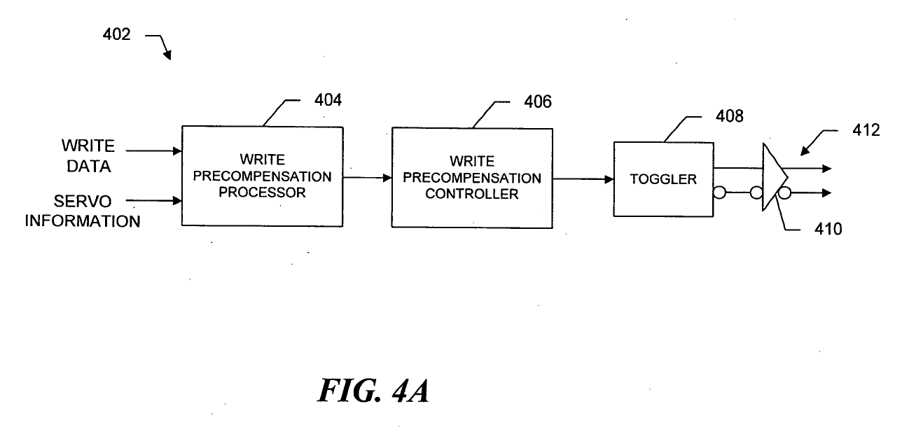

Referring now to FIGS. 3A-C, a write head, or writer, 300 has a curved write field 302 relative to a perpendicular plane (indicated by dotted line 109) across the track 108. FIG. 3A illustrates the writer centered over the sub-tracks, that is, centered with respect to the even and the odd sub-tracks. The effects of the circular write field in the two sub-tracks is the same, and the even and odd dots are written with the same intervals from an even dot to the next odd dot as from an odd dot to the next even dot. Deviations in the cross track position of the writer from the center of a track advances the position of the circular write field with respect to one sub-track and retards the position with respect to the other sub-track, as illustrated in FIGS. 3B and C. Accordingly, write transitions may be properly centered on the dots in one sub-track and not on the dots in the other sub-track, as the interval from an even dot and the next odd dot differs from the interval from an odd dot to the next even dot, as indicated by the dotted lines 111 in the drawings.

BPM write precompensation is utilized to shift the timing transitions corresponding to one of the sub-tracks, to compensate for the early or late mis-registration due to the curvature of the write field. The BPM write precompensation thus shifts the transitions associated with one sub-track earlier or later depending on the position of the write head relative to the two sub-tracks. Alternatively, the BPM write precompensation may shift the transitions corresponding to the two sub-tracks by different amounts, as needed.

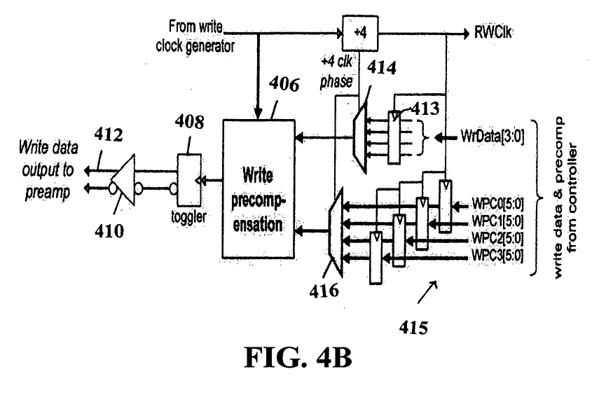

Referring now to FIG. 4A, a BPM write precompensation system 402 provides BPM write precompensation to respective write transitions before the transitions are shifted by artifacts of components in the path of the writer. For the data-dependant write precompensation, that is, precompensation for the shifts that are associated with bandwidth limitations of components in the channel, the system determines a precompensation shift for each data bit based on the known operations of the components of the channel and a short history of the data bits in the data stream.

A write precompensation processor 404 calculates the expected delays associated with the operations of the respective channel components in processing a write transition that corresponds to a given data bit based on the associated pattern of data bits within the data stream. The processor then calculates a time shift for the write transition, to precompensate for the delays the transition is expected to suffer as the signal is processed by the channel. A write compensation controller 406 then applies the time shift to the transition. In the example illustrated in FIG. 4, the controller controls the clocking of a toggler 408 that provides write transitions to input lines of an output driver 410, which in turn provides corresponding signals over respective output lines 412 to a write current driver of a preamplifier (not shown).

The processing delays associated with the bandwidth limitations of the channel components can be pre-calculated for all possible bit patterns. Accordingly, the write precompensation controller may utilize a look-up table (not shown) that is entered using the bit pattern associated with the given bit. The look-up table may instead be located within the channel, with appropriate data dependent precompensation occurring within the channel.

The BPM write precompensation system 402 may instead or in addition use servo in formation to determine the position of the write head 300 relative to the each of the sub-tracks 104 and 106 of a logical track 108. As discussed above, when the write head is not centered between the sub-tracks, the write operations to the respective sub-tracks are affected differently because of the curvature of write field 302 (FIGS. 3A-C). Accordingly, the write precompensation system processor calculates, based on the position of the write head relative to the sub-tracks, how the write transitions directed to the different tracks should be shifted to precompensate for the unequal effects of the curved write field. The write precompensation controller then time shifts the transitions directed to one of the sub-tracks by an appropriate amount to precompensate for the adverse effects of a non-centered write head.

If both forms of BPM write precompensation are used, the write precompensation shift values are combined by the write precompensation processor 404. The combined shift values are then supplied to the write precompensation controller, which shifts the write transition in time.

In the alternative arrangement discussed above, in which the data-dependent BPM write precompensation is calculated in the channel, the precompensation for the write head position is calculated before the transition enters the write channel and supplied to the precompensation processor in the channel. The precompensation processor then combines the data-dependent precompensation and the write head precompensation calculations and thereafter shifts the transition appropriately.

As an example illustrated in FIG. 4B, the write precompensation processor provides to the write precompensation controller a 4-bit write data nibble along with the corresponding precompensation shift information through registers 413, 415 and multiplexers 414, 416. The write precompensation controller also receives the write clock, and produces at the write clock rate up to four corresponding precompensated write transitions, depending on the number write transitions that result from the given 4-bit data pattern.

The BPM write precompensation is performed by blending phases of a multiple phase output signal that corresponds to the frequency of the write clock. In a BPM system, the write clock may be interpolated to operate in synchronism with the media dots 102 (FIG. 2), and thus, provision must be made in the BPM write compensation system to operate with an interpolated write clock, which would otherwise be produced as a single phase output signal.

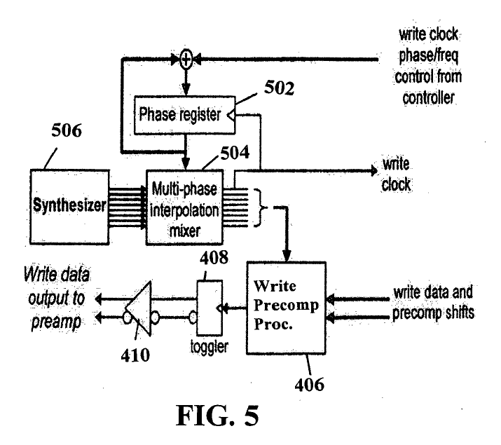

FIG. 5 illustrates a multi-phase interpolation subsystem 500 that produces multi-phase output signals that correspond to the interpolated write clock. A phase register 502 operates with write clock frequency and phase offset signals to produce control signals for a multi-phase interpolation mixer 504, which rotates and mixes the multiple phase output signals provided by a frequency synthesizer 506. The frequency synthesizer produces output signals with a center frequency that corresponds to a nominal write clock frequency associated with a media zone in which the data are being written. The multi-phase rotation and mixing of the signals produces multi-phase output signals that correspond to the interpolated write clock. The write clock frequency and phase offset signals are provided by a write clock synchronization system that is described in a co-pending patent application entitled Write Clock Control System for BPM Write Synchronization filed on even date herewith and assigned to a common assignee. The frequency and phase offset signals direct the shifting of the frequency and phase of the nominal frequency write clock signal to produce an interpolated write clock that is synchronous with the dots 102 under the write head.

The write precompensation controller 406 then blends the multi-phase output signals produced by the multi-phase interpolation mixer 504, to produce timing signals that shift the write transitions in the manner discussed above.

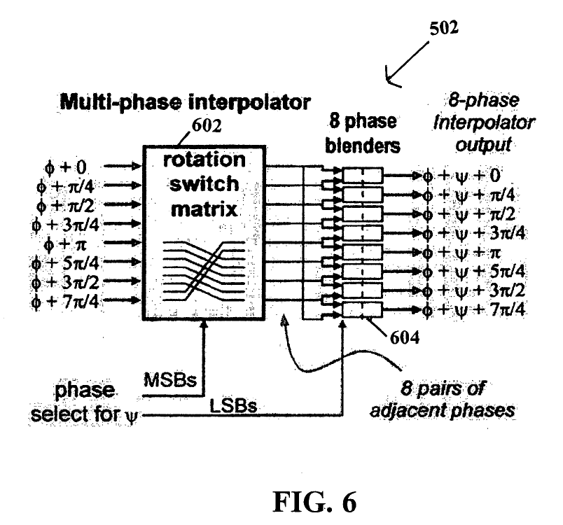

FIG. 6 depicts the multi-phase interpolation mixer 504 in more detail. The multi-phase interpolation mixer receives the multi-phase output signals of the frequency synthesizer 506 (FIG. 5), and produces multiple phase interpolated output signals, with the interpolated write clock as one of the output signals. As shown, the multi-phase interpolator utilizes a rotation switch matrix 602 to provide signals to a plurality of phase blenders 604. The blenders operate in a known manner to blend adjacent output signals, to produce multi-phase output signals that correspond to the interpolated write clock and associated interpolated multi-phase output signals.

In the example of eight input lines, the rotation switch matrix 602 consists of a plurality of multiplexers (not shown) that rotate an input signal on line n to an output signal on line n+k mod 8, where k is associated with a phase angle ψ that represents the change to the nominal frequency write clock signal required to produce the interpolated write clock. The interpolated write clock is then produced by blending the phases of signals on adjacent output lines also in accordance with the phase angle ψ. Each of eight blenders applies the same weighted blending to eight adjacent pairs of output signals as is otherwise applied by an eight to two blending in a conventional eight input line single phase interpolator. The result is the desired 8-line multi-phase output signal in which the center frequency is the single phase interpolated write clock.

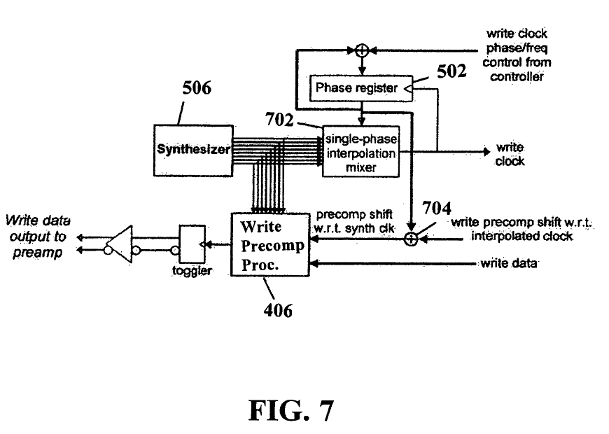

Referring now to FIG. 7, an alternative sub-system utilizes a conventional single-phase interpolation mixer 702 to produce the interpolated write clock, and provides the multi-phase output signals produced by the frequency synthesizer 506 directly to the write precompensation controller 406. In this arrangement, the phase and frequency updates for write clock interpolation are provided also to an adder 704, which digitally sums the offsets with the per-bit precompensation values provided by the write precompensation controller 404 (FIG. 4A). The sum produced by the adder directs the write precompensation controller to shift a given transition by an amount that corresponds to the shift of frequency and phase of the nominal write clock to produce the interpolated write clock, as well as to precompensate for the data-dependent operations of the write channel and, as appropriate, the sub-track offset of the write head.

The foregoing description has been directed to specific embodiments. It will be apparent, however, that other variations and modifications may be made to the described embodiments, with the attainment of some or all of their advantages. For example, the processor and controller depicted separately may be combined or a processor or controller depicted individually may consist of several processors or controllers. Further, the precompensation based on writer position may be precalculated and/or interpolated from precalculated values. The 4-bit nibble is an example, which may be any number of bits. The bit pattern media consisting of patterns of magnetic dots is an example of a media pattern, which also includes any distributed patterns of writable portions of media. Accordingly this description is to be taken only by way of example and not to otherwise limit the scope of the invention. Therefore, it is the object of the appended claims to cover all such variations and modifications as come within the true spirit and scope of the invention.

What is claimed is:

1. A write precompensation system comprising
a write precompensation processor that calculates time shift information for the timing of individual write current transitions at a write head to coincide with a media pattern under the write head; and
a write precompensation controller that shifts the individual write current transitions in accordance with the time shift information.

2. The write precompensation system of claim 1 wherein the write precompensation processor calculates the time shift information based on the position of the write head relative to even and odd sub-tracks of the media pattern.

3. The write precompensation system of claim 1 wherein the write precompensation processor calculates the time shift information based on delays associated with the processing of data bits by respective components in a path to a writer that is included in the write head.

4. The write precompensation system of claim 3 wherein the write precompensation processor further calculates the time shift information based on the position of the write head relative to even and odd sub-tracks of the media pattern.

5. The write precompensation system of claim 2 further including
the write precompensation controller supplying the compensated write current to the write head; and
the write head writing the transitions to the media pattern.

6. The write precompensation system of claim 4 wherein the write precompensation controller includes a multiple phase interpolator that blends phase components of an interpolated write clock signal in accordance with the time shift information to produce a signal that time shifts the transitions in the write current.

7. The write precompensation system of claim 4 wherein the write precompensation controller includes in the time shift information phase and frequency offset information associated with the interpolated clock.

8. A method of write precompensation comprising the steps of
calculating time shift information for the timing of individual write current transitions at a write head to coincide with a media pattern under the write head; and
shifting the individual write current transitions in accordance with the time shift information.

9. The method of claim 8 wherein the step of calculating the time shift information includes calculating the time shift information based on the position of a write head relative to even and odd sub-tracks of the media pattern.

10. The method claim 8 wherein the step of calculating the time shift information includes calculating the time shift information based on delays associated with the processing of data bits by respective components in a path to a writer that is included in the write head.

11. The method of claim 10 wherein the step of calculating the time shift information further includes calculating the time shift information based on the position of a write head relative to even and odd sub-tracks of the media pattern.

12. The method of claim 9 further including the steps of
supplying the compensated write current to the write head; and
writing the transitions to the media pattern.

13. The method of claim 11 further including blending phase components of an interpolated write clock signal in accordance with the time shift information to produce a clock signal that time shifts the transitions.

14. The method of claim 11 further including blending phase components of a nominal write clock signal to include in the time shift information phase and frequency offset information associated with an interpolated clock.

15. A write precompensation system comprising
a write precompensation processor that calculates time shift information for the timing of individual write current transitions at a write head to coincide with a media pattern under the write head, the write precompensation processor calculating the time shift information based on the position of the write head relative to even and odd sub-tracks of the media pattern, and
a write precompensation controller that shifts the individual write current transitions in accordance with the time shift information.

16. The system of claim 15 wherein the write precompensation processor further calculates the time shift based on delays associated with the processing of data bits by respective components in a path to a writer that is included in the write head.

17. The system of claim 16 further including
the write precompensation controller supplying the compensated write current to the write head; and
the write head writing the transitions to the media pattern.

18. The system of claim 15 wherein the write precompensation controller includes a multiple phase interpolator that blends phase components of an interpolated write clock signal in accordance with the time shift information to produce a signal that time shifts the transitions in the write current.

19. The system of claim 15 wherein the write precompensation controller includes in the time shift information phase and frequency offset information associated with an interpolated clock.

20. The system of claim 15 wherein the write precompensation controller manipulates a nominal write clock signal to include in the time shift information phase and frequency offset information associated with an interpolated clock.

21. The system of claim 15 wherein the media pattern is bit patterned media consisting of patterns of dots.
